(19) United States
(12) Patent Application Publication
(10) Pub. No.: US 2014/0252877 A1
(43) Pub. Date: Sep. 11, 2014

(54) ARTIFICIAL MAINS NETWORK IN THE SECONDARY CIRCUIT OF THE CONTACTLESS ENERGY TRANSFER

(71) Applicant: Faical Turki, Berkamen (DE)

(72) Inventor: Faical Turki, Berkamen (DE)

(73) Assignee: PAUL VAHLE GMBH & CO. KG, Kamen (DE)

(21) Appl. No.: 14/352,794

(22) PCT Filed: Sep. 14, 2012
(86) PCT No.: PCT/EP2012/068129

§ 371 Date: Apr. 18, 2014

(30) Foreign Application Priority Data
Oct. 18, 2011 (DE) 102011116057.8

(51) Int. Cl. H01F 38/14

(52) U.S. Cl. CPC H01F 38/14
USPC 307/104

(57) ABSTRACT

The invention relates to an inductive energy transfer system, having at least one primary coil (Sp₁) and at least one secondary coil (Sp₂), which are coupled or able to be coupled with one another magnetically and which form a primary-side and a secondary-side resonant circuit (Reₚᵣᵢ, Reₛₑₖ) having at least one capacitance (C₁, C₂) respectively, characterised in that a primary-side inverter (15) generates a pulsed voltage (U_{W}), in particular a pulsed square wave voltage, from a unipolar primary voltage (|U_{N}|) or a DC voltage (U_{G}) and supplies the primary-side resonant circuit (Reₚᵣᵢ), wherein the primary-side inverter (15) is pulsed or adjusted or the pulse of the voltage, in particular square wave voltage, generated by the primary-side inverter (15), is selected or adjusted in such a way that a secondary AC voltage (Uᵢ) induced in the secondary-side resonant circuit (Reₛₑₖ) and having a carrier frequency (f_{T}) results, wherein the amplitude of the secondary AC voltage (Uᵢ) oscillates at mains frequency (f₀), and that a device (E) is connected downstream of the secondary-side resonant circuit (Reₛₑₖ), said device generating a bipolar secondary-side output voltage (U_{A}) from the voltage (Uᵢ) present at the output of the secondary-side resonant circuit (Reₛₑₖ), wherein the frequency (f_{A}) of the secondary-side output voltage (U_{A}) is equal to the mains frequency (f₀), and that the device (E) has four power semiconductors (L₁, L₂, L₃, L₄; L₅, L₆, L₇, L₈; L₉, L₁₀, L₁₁, L₁₂), which form two groups (Gr₁;Gr₂) of, in particular, equally as many power semiconductors, and the power semiconductors of a group (Gr₁, Gr₂) are connected together by means of a group control signal (G₁; G₂), wherein the groups (Gr₁, Gr₂) are alternately connected actively by means of the group control signals (G₁; G₂).

The present invention relates to an inductive energy transfer system having at least one primary coil and at least one secondary coil, which are coupled with one another and which form a primary-side and secondary-side resonant circuit having at least one capacitance.

In conventional contactless energy transfer systems, a DC voltage is always firstly generated from a primary-side input AC voltage having mains frequency, said DC voltage subsequently being converted into an AC voltage having a higher frequency by means of an inverter and being supplied to the primary-side resonant circuit, consisting of primary coil and capacitance. Using the magnetic coupling between the primary coil and the secondary coil, the AC current of a higher frequency that is present at the output of the secondary-side resonant circuit, which is formed from the secondary coil and at least one capacitance, is firstly smoothed, in order to then generate a secondary-side output voltage corresponding to the primary-side input AC voltage by means of a further inverter. In order to be able to supply secondary-side charges with an AV voltage similar to the mains, therein the secondary-side induced voltage must be rectified and a trapeze or sinusoidal voltage must be generated by means of the secondary-side inverter. In the case of the use of such energy transfer systems, a PFC step (Power Factor Correction) is necessary, especially in non-industrial use, so that the mains feedback and the power factor fulfil the required legal conditions.

An energy transfer system is known from WO2011/127449, in which an AC voltage is able to be generated on the secondary side from the primary-side induced voltage by means of a rectifier and a polarity reversing member.

The object of the present invention is to provide an inductive energy transfer system, which is simpler to construct and consists of fewer parts and yet fulfils the legal conditions.

This object is solved according to the invention with an inductive energy transfer system having the features of claim 1. Further advantageous embodiments of the inductive energy transfer system according to claim 1 result from the features of the sub-claims.

The inductive energy transfer system according to the invention can also be referred to as a contactless energy transfer system. Therein, it is understood by “contactless” that no mechanical contact has to exist between the primary and the secondary side. Provided that the secondary coil is enclosed in a housing, the housing can also be directly supported on the likewise enclosed primary side.

The energy transfer system according to the invention has a primary-side inverter, which generates a pulsed square wave voltage from a unipolar primary voltage or a DC voltage and supplies this to the primary-side resonant circuit, consisting of coil and capacitance. Therein, the reactive voltage is compensated for via the capacitances. In the sense of the invention, a “unipolar voltage” is understood to be a rectified AC voltage.

The unipolar primary voltage necessary on the input side for the primary rectifier can, for example, be generated by means of a rectifier from an input AC voltage having mains frequency. The unipolar voltage supplied to the primary-side inverter has an alternating component due to the low-capacitance voltage intermediate circuit.

The primary-side inverter is pulsed or adjusted or the pulse of the of the square wave voltage generated by the primary-side inverter is selected or adjusted in such a way that a secondary AC voltage induced in the secondary-side resonant circuit having a carrier frequency results, wherein the amplitude of the secondary AC voltage oscillates at mains frequency and can also optionally be in phase with this. The carrier frequency advantageously lies in the kHz-range. “Mains frequency” is understood to be the national predominant mains frequency, e.g. 50 Hz for Europe and 60 Hz for the USA. Provided that the primary current is in phase with the frequency of the mains, the current flowing in the primary resonant circuit is synchronised with the mains. It is hereby ensured that the induced secondary voltage also has the same form.

The induced secondary AC voltage can have the form equal to or approximately

usek(t)=Usek*sin(2*π*fT*t)*sin(2*π*f0*t).

The magnetic circuit, which is situated in resonance with the compensation capacitances, has a current having the same frequency due to excitation by the inverter voltage of the primary-side inverter. This current generates a magnetic field which serves the energy transfer to the secondary circuit.

The oscillating high-frequency voltage present at the output of the secondary resonant circuit is converted into an, if possible, sinusoidal secondary-side output voltage by means of a secondary-side device. Therein, the high-frequency component is eliminated by the rectification.

Therein, a voltage results, which has the form of the mains voltage and whose amplitude is proportional to the magnetic flux in the secondary coil.

In the case of constant magnetic quantities, the primary current can be advantageously selected or adjusted such that the secondary-side output voltage corresponds to the mains voltage, i.e. 230 VA, 50 Hz.

In the case of variable magnetic coupling, the primary-side inverter must regulate the primary current in the primary coil such that the secondary-side output voltage remains constant. For this purpose, a feedback can advantageously occur via a channel of the secondary circuit to the primary circuit, which supplies the information about the secondary voltage to the control device of the primary-side inverter.

The device can comprise a secondary-side inverter and a polarity reversing member connected downstream, which are implemented by discrete circuits. It is, however, also possible to combine the secondary-side rectifier and the polarity reversing member of the device into one power semiconductor step. The effectiveness can advantageously be improved by the combination. The secondary-side rectifier can have a low-capacitance smoothing capacitor, such that a voltage is present at the output of the rectifier, which corresponds to a rectified, in particular sinusoidal, mains voltage.

The principal behind the invention corresponds approximately to the principal of amplitude modulation in the signal transfer. The high-frequency carrier frequency oscillates at mains frequency. Therein, the high-frequency induced voltage is rectified via a half wave of the mains frequency, i.e. the envelope. Therein, the local minimum of the envelope of the secondary voltage must be detected so that alternately the polarity of the rectified secondary voltage can be reversed.

In a first possible embodiment, the secondary-side inverter and the polarity reversing member are not combined in a circuit, wherein a rectified mains voltage is present at the output of the secondary-side rectifier, which is polarised into a bipolar, advantageously sinusoidal, output voltage by means of the polarity reversing member. For this purpose, the polarity of each second half wave is to be reversed. This can occur by means of a semiconductor polarity reversing member.

Provided that the secondary-side rectifier and the polarity reversing member are combined into a power semiconductor step, the rectification and the polarity reversal occur with the same power semiconductor.

A smoothing memory, in particular in the form of a capacitor, serves for the smoothing and stabilising of the secondary output voltage.

The secondary-side device can, in particular, have four power semiconductors, which form two groups of, in particular, equally as many power semiconductors. The power semiconductors of a group can be connected together by means of a group control signal, wherein only one of the groups is connected actively respectively. A bipolar, in particular sinusoidal, secondary-side output voltage is generated by the alternating active connection of the groups.

A downtime is provided between the active phases of the groups, during which both groups are inactive, i.e. both groups of power semiconductors are closed and thus do not have a rectifying effect, whereby it is prevented that over-voltages form, which can lead to the destruction of the semiconductors.

Several circuit-technological implementations are possible.

Thus, in a second embodiment, the device can have four reverse conducting power semiconductors, which form two groups each of two power semiconductors, wherein the power semiconductors of each group are connected in series and are connected actively by means of the same group control signal. The anode of the one and the cathode of the other power semiconductor of a first group are connected electrically to one another at a first connection point. The same applies for the power semiconductors of the other second group, which are connected electrically to one another at a second connecting point. Therein, the connection points form the terminal points for the secondary-side resonant circuit. Additionally, a freewheeling diode is connected in parallel to each power semiconductor respectively. Provided that reverse conducting IGBTs or MOSFETs are used, the freewheeling diode is implemented in this already and the additional freewheeling diodes are not necessary. Therein, the two groups are connected to one another with the free anodes of their one power semiconductor at a further connection point and thus are connected in series, wherein at least on capacitor is connected in parallel, parallel to the series circuit of the two groups. The secondary-side output voltage is tapped at the clamps of the capacitor.

In a third and fourth embodiment, the device has two groups of power semiconductors, whereby each group has a reverse conducting and a reverse blocking power semiconductor respectively.

In the third embodiment, the reverse conducting power semiconductor of the first group and the reverse blocking power semiconductor of the second group are connected electrically to one another with their anodes at a connection point and form a first series circuit. A second series circuit is formed by the reverse blocking power semiconductor of the first group and the reverse conducting power semiconductor of the second group, which are connected electrically to one another with their anodes at a further connection point. A freewheeling diode is connected in parallel to the reverse conducting power semi-conductors respectively, provided that this is not implemented already in this in the use of a reverse conducting IBGT or MOSFET. The two series circuits are connected in parallel to the output capacitor, wherein the two connection points form the terminal points for the secondary-side resonant circuit.

In the fourth embodiment, the two power semiconductors of each group are connected in series and are connected actively at the same time by means of the respective group control signal. Therein, the anode of one and the cathode of the other power semiconductor of the one first group are connected electrically to one another at a first connection point respectively and the anode of the one and the cathode of the other power semiconductor of the other second group are connected to one another at a second connection point. The two connection points form the terminal points for the secondary-side resonant circuit. Additionally, freewheeling diodes are connected in parallel to the reverse conducting power semiconductors respectively. In the use of a reverse conducting IGBT, or in particular MOSFET, an additional freewheeling diode is not necessary, as is described above. The anode of the reverse blocking power semiconductor of the first group is connected electrically conductively to the cathode of the reverse blocking power semiconductor of the second group. The cathode of the reverse blocking power semiconductor of the first group is connected electrically conductively to the anode of the reverse blocking power semiconductor of the second group, wherein the cathodes of the reverse conducting power semiconductors are connected to the terminals of the output capacitors.

A control device generates the group control signals, by means of which the power semiconductors are controlled. Therein, the control device detects or calculates the local minimum of the envelope of the induced secondary voltage and optionally actively connects the groups or individual power semiconductors of the groups, in particular alternately, by means of the group control signals. Therein, the group signals are generated in such a way that a sufficient downtime between the active phases of the two groups exists, whilst the two groups of power semiconductors are inactive.

Advantageously, the energy transfer system according to invention does not need a PFC step.

Possible electrical circuits of the embodiments described above are illustrated in more detail below by means of drawings.

Here are shown:

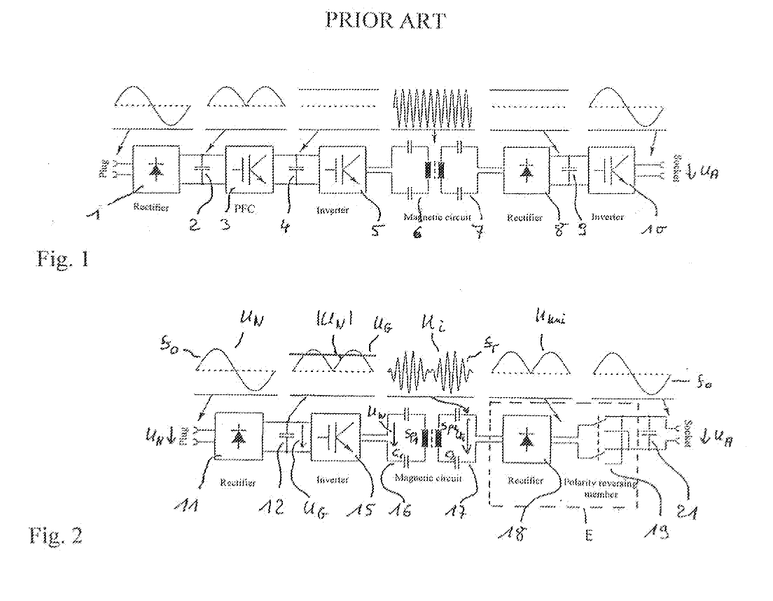

FIG. 1: An energy transfer system according to prior art;

FIG. 2: one possible embodiment, wherein the secondary-side device comprises a rectifier and a polarity reversing member;

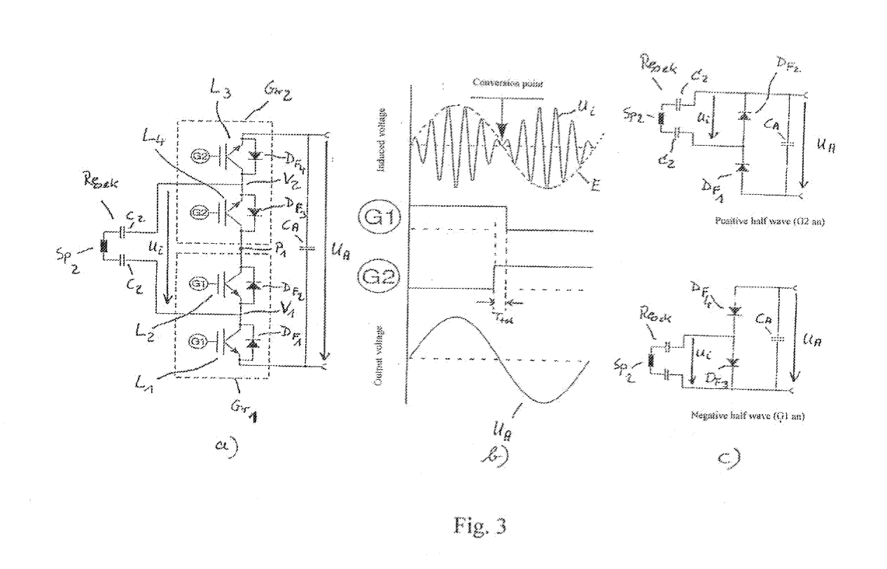

FIG. 3a: first possible embodiment, wherein the device has four reverse conducting semiconductors, in particular in the form of IGBTs, which implement the rectification and polarity reversal;

FIG. 3b: voltage progressions and control signals;

FIG. 3c: equivalent circuit diagrams;

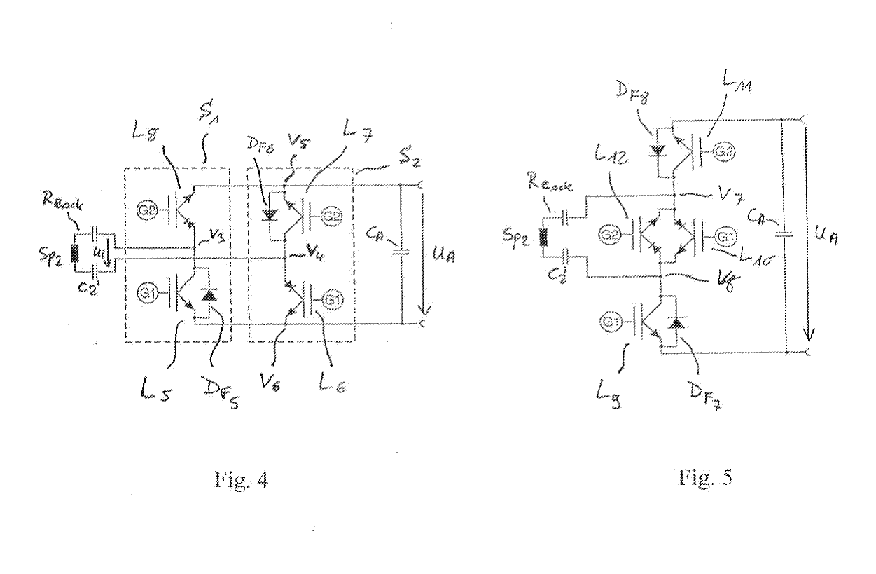

FIG. 4: circuit for the second possible embodiment;

FIG. 5: circuit for the third possible embodiment, which offers a step-up possibility.

FIG. 1 show an inductive energy transfer system according to prior art. The primary-side rectifier 1 is supplied with a mains voltage, for example 230 VA, 50 Hz, via a plug. The rectifier 1 rectifies this to a unipolar voltage having an alternating component, which is able to be tapped at the capacitance 3 and is depicted above the block diagram. This unipolar voltage is supplied to a PFC step (Power Factor Correction), so that the mains feedback and the power factor fulfil the required legal conditions. A DC voltage is generated by means of a capacitor connected downstream, said DC voltage being pulsed by a primary-side inverter 5 in such a way that a constant, high-frequency voltage is induced in the secondary-side series resonant circuit 7 via the primary-side series resonant circuit 5. This is rectified into a DC voltage by means of a rectifier 8 connected downstream in connection with the smoothing capacitor 9, said DC voltage being converted into a sinusoidal output voltage U_{A} by means of the secondary-side inverter 10.

In FIG. 2, a block diagram for one embodiment of the inductive transfer system according to the invention is depicted. A rectifier 11 is arranged on the primary side, which generates a unipolar voltage |U_{N}| from a mains AC voltage U_{N} having the frequency f₀. Therein, the capacitor 12 is low-capacitance such that the unipolar voltage |U_{N}| still changes with the mains frequency f₀. It is also possible that the smoothed voltage U_{G} is generated by means of the capacitor 12 connected downstream, said smoothed voltage U_{G} serving as an input voltage for the primary-side inverter 15. Provided that a DC voltage, for example from a battery, is available, the primary-side inverter 11 can be dispensed with. Provided that a DC voltage serves as an input voltage U_{G} for the inverter, the inverter 15, as is described above, must be pulsed differently than in the case of the use of the unipolar voltage |U_{N}|.

Provided that the unipolar voltage |U_{N}| is used as an input voltage for the inverter 15, it is principally sufficient to pulse the inverter 15 with a constant frequency f_{W} so that an induced voltage Uᵢ results, as is depicted in FIGS. 2 and 3b, which oscillates at mains frequency f₀. Therein, the ripple of the voltage |U_{N}| is transferred to the induced voltage Uᵢ. Therein, the pulse frequency f_{W} is to be selected such that an induced voltage Uᵢ results having the frequency f_{T}, wherein f_{T} lies in the kHz-range. The pulse frequency of the square wave voltage U_{W} can either be fixed or adapted to the resonant frequency of the primary circuit 16. The inverter 15 supplies a primary current with its pulse, which flows through the primary coil Sp₁ and the capacitor C₁ connected in series (series resonant circuit 16), the envelope EH of which has the mains frequency f₀ and if possible is in phase with this. The envelope EH is thus synchronised with the mains, whereby the induced voltage Uᵢ has the same form as the primary current. The amplitude of the carrier AC voltage oscillates at sin(2*π*f₀*t), i.e. at mains frequency f₀. The secondary resonant circuit 17 is likewise formed by the series circuit from secondary coils Sp₂ and capacitors C₂. The induced voltage Uᵢ is transformed into the unipolar AC voltage Uᵤₙᵢ by the inverter 18 connected downstream, wherein these have the frequency f₀. A polarity reversing member connected downstream generates the desired bipolar and preferably a sinusoidal output voltage U_{A} having the frequency f₀ from the unipolar AC voltage Uᵤₙᵢ, the smoothing capacitor 21 serving for the smoothing of this. The rectifier 18 and the polarity reversing member 19 together form the secondary-side device E, which forms the secondary-side output voltage U_{A} from the induced voltage Uᵢ.

Provided that the input voltage of the inverter 15 is a constant input voltage U_{G}, the inverter 15 must be pulsed by means of pulse width modulation or wave pulsing, so that an induced voltage Uᵢ results, the envelope of which oscillates as is shown.

FIG. 3a shows a first possible embodiment of the secondary-side device E, wherein the rectifier 18 and polarity reversing member 19 illustrated from FIG. 2 are replaced by a series circuit of four reverse conducting power semiconductors L₁-L₄, which form the output voltage U_{A} from the induced voltage Uᵢ. The effectiveness with respect to the circuit according to FIG. 2 is clearly improved by the combination of rectifier and polarity reversing member.

The power semiconductors L₁-L₄ form two groups Gr₁ and Gr₂ each having two power semiconductors, wherein the power semiconductors of a group Gr₁ or Gr₂ are controlled or connected at the same time by the group control signal G₁ or G₂ generated by a control device and are connected to one another in series with the same flow direction. Freewheeling diodes D_{F} are connected parallel to all power semiconductors L₁-L₄. The freewheeling diodes D_{F} can also be implemented in the power semiconductors L₁₋₄. The series circuits of groups Gr₁ and Gr₂ are likewise connected in series, wherein, however, the flow direction of the power semiconductors L₁, L₂ of the first group Gr₁ is connected in an opposing manner to the flow direction of the power semiconductors L₃, L₄ of the second group Gr₂. Thus, the anode of the power semiconductor L₂ is connected to the anode of the power semiconductor L₃ at the connection point P₁. The connection points V₁ and V₂ are the connection points of the two power semiconductors of one group and form the connection points for the secondary series resonant circuit Reₛₑₖ, consisting of secondary coil Sp₂ and capacitors C₂. The capacitor C_{A} is connected in parallel to the series circuits of the groups Gr₁ and Gr₂, at which the secondary output voltage U_{A} is present.

The FIG. 3b shows the voltage progression of the induced voltage Uᵢ (above), the level of the group control signals G₁ and G₂ as well as the output voltage U_{A}. The amplitude of the induced voltage Uᵢ oscillates at mains frequency f₀, whereby an envelope EH occurs. The group control signals G₁ and G₂ are adjusted to the progression of the envelope EH. The control device that is not depicted is formed in such a way that it detects the minimum of the envelope EH of the induced voltage U, or detects the temporal progression using signals of the primary-side inverter 15 such that a measurement of the induced voltage Uᵢ is not required.

If the signal G1 is “high” for the reverse conducting power semiconductor, the group Grₓ is “inactive” in the sense of the invention, as the power semiconductors thereof are conducting and the power semiconductors do not assume a blocking, i.e. rectifying, function. A group or a power semiconductor are, however, understood as active groups Grₓ if they assume a blocking function and thus a rectifying function.

The group control signals G₁ and G₂ are switched on alternately after each local minimum of the envelope EH of the induced voltage Uᵢ, wherein before the “active” connection of the next group, the preceding switched-on group must be inactively connected at least for a downtime Tₜₒₜ. During the downtime Tₜₒₜ, all power semiconductors L₁ to L₄ are thus closed. This serves to avoid overvoltage. The downtime Tₜₒₜ can lie in the region of 100 ns.

The FIG. 3c shows the equivalent circuit diagrams for the alternatingly conductively connected groups Gr₁ and Gr₂. Therein, the upper equivalent circuit diagram shows the circuit which results if during the positive half wave of the envelope EH, the power conductors L₃ and L₄ are connected conductively by means of the group control signal G2. Whilst the semiconductor bridge formed by the group Gr₂ is switched on, it presents a bipolar short circuit. The open semiconductor bridge, which is formed by the power semiconductors L₁ and L₂, forms a voltage doubler having its freewheeling diodes D_{F1}, D_{F2}. Whilst the free-wheeling diode DF₂ connected in parallel to the resonant circuit is conducting, the series capacitor C₂ charged to peak voltage. If the other freewheeling diode DF₁ conducts, the sum from the series capacitor voltage and the peak voltage of the next half wave is connected to the output capacitor. The power semiconductors are connected actively to the mains frequency such that no considerable switching losses result. A synchronisation with the resonance frequency enables a voltage-free connection and thus a further optimisation of the effectiveness.

The lower equivalent circuit diagram of FIG. 3c shows the circuit, which results if during the negative half wave of the envelope EH, the power semiconductors L₁ and L₂ are connected conductively by means of the group control signal G₁. Whist the semiconductor bridge formed by the group Gr₁ is switched off, it presents a bipolar short circuit. The open semiconductor bridge, which is formed by the power semiconductors L₃ and L₄, forms a voltage doubler with its freewheeling diodes D_{F3}, D_{F4}. Whilst the freewheeling diode DF₃ connected in parallel to the resonant circuit is conducting, the series capacitor C₂ is charged to the peak voltage. If the other freewheeling diode DF₄ conducts, the sum from the series capacitor voltage and the peak voltage of the next half wave is connected to the output capacitor.

In the case of a variation of the control of the circuit depicted in FIG. 3a, the power semi-conductors of a group Grᵢ are actively or inactively connected independently of each other. Hereby, a step-up of the output voltage is possible. This occurs due to a short-circuiting of the secondary voltage via the two power semiconductors L₂ and L₃. Hereby, the secondary resonant circuit is charged with energy. After the opening of the power semiconductors L₂ and L₃, the energy stored in the secondary resonant circuit can flow freely via the freewheeling diodes to the output capacitor C_{A}. This is advantageous in the case of a variable air gap between primary and secondary circuit or a non-constant amplitude of the induced voltage Uᵢ in the secondary circuit.

For the circuits depicted and explained in FIGS. 3a to 3c, IGBTs, MOSFETs etc. can advantageously be used as reverse conducting semiconductors. It can potentially be disadvantageous that three power semiconductors are always in a current path. In order to minimise the accompanying conduction losses further, the circuits can be used according to FIGS. 4 and 5, which use reverse blocking power semiconductors.

In the circuit depicted in FIG. 4 uses a reverse conducting power semiconductor (IGBT) L₅, L₇ and a reverse blocking power semiconductor (reverse blocking IGBT) L₆, L₈ per group Gr₁ or Gr₂ respectively. The reverse blocking power semiconductor behaves as a bipolar idle cycle in the open state and as a diode in the switched-on state. The reverse blocking power semiconductors L₆, L₈ are switched on by a “high” gate signal, i.e. in the conducting state, wherein in this state the reverse blocking diode thereof has a rectifying effect. The reverse blocking power semiconductor L₆, L₈ is thus “active” in the sense of the invention, if it is switched on. The reverse conducting power semiconductors L₅, L₇ are, however, “active” in the sense of the invention when they are switched off, i.e. the gate signal thereof is “low”. A freewheeling diode D_{F5} or D_{F6} must be connected in parallel, parallel to the reverse conducting power semiconductors respectively, provided that it is not already implemented in the power semiconductor. Provided that the power semiconductors L₅, L₆ or L₇, L₈ of each group Gr₁ or Gr₂ are controlled via the group control signals G1 and G2 depicted in FIG. 3b, the function is the same as that of the circuit described in FIGS. 3a to 3c, having the single difference that the number of the power semiconductors reduces by half in the current path. Hereby, the conduction losses lower decrease and a better effectiveness is achieved. In the case of the circuit depicted in FIG. 4, however, a separated and different control of the power semiconductors of a group is not possible for the purpose of stepping-up the output voltage due to the circuit, as a bipolar short circuit of the secondary circuit is not possible.

The circuit depicted in FIG. 5, which likewise uses a reverse conducting power semiconductor L₉, L₁₁ and a reverse blocking power semiconductor L₁₀, L₁₂ per group Gr₁ or Gr₂, wherein likewise freewheeling diodes D_{F7}, D_{F8} are connected in parallel to the reverse conducting power semiconductors L₉, L₁₁, enables a short circuit of the secondary-side series resonant circuit Reₛₑₖ, whereby the step-up of the output voltage U_{A} is possible and only two power semiconductors are in a current path. The circuit depicted in FIG. 5 thus connects the advantages of the circuits shown in FIGS. 3 and 4.

The equivalent circuit diagrams of FIG. 3c are valid just as much for the circuits of FIGS. 4 and 5.

1. An inductive energy transfer system, including:
at least one primary coil;
at least one secondary coil, wherein the at least one primary coil and the at least one secondary coil are configured to be coupled with one another magnetically, and wherein the at least one primary coil and the at least one secondary coil form a primary-side resonant circuit and a secondary-side resonant circuit having at least one capacitance, respectively;
a primary-side inverter configured to generate a pulsed voltage from a unipolar primary voltage or a DC voltage and to supply the primary-side resonant circuit, wherein the primary-side inverter is pulsed or adjusted or the pulse of the voltage generated by the primary-side inverter is selected or adjusted in such a way that a secondary AC voltage induced in the secondary-side resonant circuit and having a carrier frequency results, wherein an amplitude of the secondary AC voltage oscillates at a mains frequency; and
a device connected downstream of the secondary-side resonant circuit and configured to generate a bipolar secondary-side output voltage from the voltage present at an output of the secondary-side resonant circuit, wherein a frequency of the secondary-side output voltage is equal to the mains frequency, wherein the device comprises four power semiconductors that form two groups having equal numbers of power semiconductors, wherein the power semiconductors of a group are connected together by means of a group control signal, wherein the groups are alternately connected actively by means of the group control signals.

2. The inductive energy transfer system according to claim 1, further including a first rectifier on the primary side and configured to rectify an AC voltage having the mains frequency into a unipolar primary voltage that is present at the primary-side inverter on an input side.

3. The inductive energy transfer system according to claim 1, wherein the device comprises four power semiconductors that form the two groups having equal numbers of power semiconductors, wherein the power semiconductors of a group are connected together either by means of a group control signal, wherein the groups are alternately connected actively by means of the group control signals, or are connected by means of separate group control signals, configured so that the secondary series resonant circuit is able to be shorted and configured to enable an increase of the output voltage.

4. The inductive energy transfer system according to claim 1, wherein only one group of power semiconductors is connected actively and a downtime exists between active phases of the groups, in which the two groups are inactive.

5. The inductive energy transfer system according to claim 1, wherein the device comprises four reverse conducting power semiconductors that form the two groups of two power semiconductors, wherein the power semiconductors of each group are connected in series and are actively connected by means of a respective group control signal, wherein an anode of one power semiconductor and a cathode of another power semiconductor of a first group are connected to one another electrically at a first connection point, and wherein an anode of one power semiconductor and a cathode of another power semiconductor of a second group are connected to one another electrically at a second connection point, and wherein the first and second connection points form terminal points for the secondary-side resonant circuit, and
the inductive energy transfer system further comprising a respective freewheeling diode connected in parallel to a respective power semiconductor, if no freewheeling diode is implemented in a respective power semiconductor,
wherein the two groups are connected to one another with free anodes of their respective power semiconductors at a point and thus are connected in series, and
wherein at least one capacitor is connected in parallel, parallel to the series circuit of the two groups and the secondary-side output voltage is present at the capacitor.

6. The inductive energy transfer system according to claim 1, wherein each group is formed from one reverse conducting power semiconductor, and one reverse blocking power semiconductor, respectively.

7. The inductive energy transfer system according to claim 6, wherein the reverse conducting power semiconductor of a first group and the reverse blocking power semiconductor of a second group are connected to one another electrically with their anodes at a first connection point and form a first series circuit,
wherein the reverse blocking power semiconductor of the first group and the reverse conducting power semiconductor of the second group are connected to one another electrically with their anodes at a second connection point and a form a second series circuit,
wherein the inductive energy transfer system further includes respective freewheeling diodes connected in parallel to the respective reverse conducting power semiconductor, if no freewheeling diode is implemented in the respective reverse conducting power semiconductor, and
wherein the first and second series circuits are connected in parallel to the at least one capacitor, and the first and second connection points form terminal points for the secondary-side resonant circuit.

8. The inductive energy transfer system according to claim 6, wherein the power semiconductors of each group are connected in series and are connected actively by means of a respective group control signal of the respective,
wherein an anode of one power semiconductor and a cathode of another the power semiconductor of a first group are connected to one another electrically in a first connection point and an anode of one power semiconductor and a cathode of another power semiconductor of a second group are connected to one another in a second connection point,
wherein the first and second connection points form terminal points for the secondary-side resonant circuit,
wherein the inductive energy transfer circuit further includes respective freewheeling diodes connected in parallel to respective reverse conducting power semiconductors if freewheeling diodes are not already implemented in the reverse conducting power semiconductors,
wherein an anode of the reverse blocking power semiconductor of the first group is connected electrically conductively to a cathode of the reverse blocking power semiconductor of the second group and a cathode of the reverse blocking power semi-conductor of the first group is connected electrically conductively to an anode of the reverse blocking power semiconductor of the second group and the cathodes of the reverse conducting power semiconductors are connected to terminals of the at least one output capacitor.

9. The inductive energy transfer system according to claim 1, further including a control device configured to actively connect the power semiconductors of the groups by means of the group control signals alternately after each local minimum of an envelope of the secondary-side output voltage.

10. The inductive energy transfer system according to claim 9, wherein, prior to an active connection of a next group, both groups of power semiconductors are inactive during a downtime.

11. The inductive energy transfer system according to claim 2, further including:
a secondary-side second rectifier; and
a polarity reversing device integrated into the secondary-side second rectifier or forming a component of the secondary-side rectifier.

12. The inductive energy transfer system according to claim 1, wherein a pulse frequency of the primary-side inverter is constant or is adapted to a resonant frequency of the primary-side resonant circuit.

13. The inductive energy transfer system according to claim 1, wherein a reactive voltage component of the at least one primary and a reactive voltage component of the at least one secondary coil are compensated for by means of capacitances.

14. The inductive energy transfer system according to claim 1, further including a primary-side smoothing capacitor configured to smooth the unipolar primary voltage.

15. The inductive energy transfer system according to claim 1, wherein the secondary-side output voltage has the form of a single-phase AC voltage, an amplitude of which is proportional to magnetic flux in the secondary coil.

16. The inductive energy transfer system according to claim 1, wherein the primary-side inverter is configured to set or adjust a primary current flowing through the primary coil depending on a required amplitude of the secondary-side output voltage.

17. The inductive energy transfer system according to claim 1, wherein the primary-side inverter is configured to adjust a primary current flowing through the primary coil such that an amplitude of the secondary-side output voltage corresponds to an amplitude progression or such that an envelope of the secondary-side output voltage corresponds to a single-phase AC voltage.

18. The inductive energy transfer system according to claim 1, further including a measurement device configured to determine an amplitude of the secondary-side output voltage and to transmit a corresponding signal to the primary-side inverter.

19. The inductive energy transfer system according to claim 1, wherein a frequency of the secondary AC voltage lies between 10 kHz and 150 kHz.

20. The inductive energy transfer system according to claim 1, wherein the secondary AC voltage is equal to or approximately uₛₑₖ(t)=ûₛₑₖ·sin(2πf_{T}t)·sin(2πf₀t), where ûₛₑₖ is an amplitude, f_{T} is the carrier frequency, and f₀ is the mains frequency.

21. The inductive energy transfer system according to claim 1, wherein the primary-side inverter is pulsed by a constant pulse, using PWM or wave pulsing.
